(19) United States
(12) Patent Application Publication
(10) Pub. No.: US 2015/0208712 A1
(43) Pub. Date: Jul. 30, 2015

(54) Agricultural Apparatus For Collecting, Cutting and/or Processing Produce and Methods Thereof

(71) Applicant: FresCO Collaboration LLC, Sidney, OH (US)

(72) Inventors: Philip M. Gilardi, Sidney, OH (US); Travis W. Brux, Sidney, OH (US); Robert E. Douglass, West Milton, OH (US); Armand M. Christen, Lockwood, CA (US); Randy L. Wilson, Salinas, CA (US)

(73) Assignee: FresCO Collaboration LLC, Sidney, OH (US)

(21) Appl. No.: 14/607,461

(22) Filed: Jan. 28, 2015

Related U.S. Application Data
(60) Provisional application No. 61/932,452, filed on Jan. 28, 2014.
(60) Provisional application No. 62/018,715, filed on Jun. 30, 2014.

(51) Int. Cl. A23N 15/00; B26D 7/06; B26D 7/24; B26D 1/15

(52) U.S. Cl. CPC A23N 15/003; B26D 1/15; B26D 7/0625; B26D 7/24

(57) ABSTRACT

Agricultural apparatuses and systems for collecting, cutting, and/or processing produce. The produce processing system includes a feed conveyor, a first belt, a first spray assembly, a processing station, the processing station including a housing mounted to the feed conveyor, a mandrel assembly coupled to the feed conveyor, the mandrel assembly including a first rotating blade, an engagement sensor coupled to the housing and the feed conveyor, a stop switch coupled to the feed conveyor, where the stop switch is repositionable between an engaged position and a disengaged position, and an operator controller communicatively coupled to the flow sensor, the engagement sensor, and the stop switch, wherein the operator controller stops a rotation of the first belt based on at least one of a detection of a signal from the engagement sensor, a detected flow rate from the flow sensor, and an engagement of the stop switch.

### CROSS REFERENCE TO RELATED APPLICATIONS

The present application claims the benefit of and priority to U.S. Provisional Patent Application 61/932,452 entitled “Agricultural Apparatus for Collecting, Cutting and/or Processing Produce and Methods Thereof,” which was filed on Jan. 28, 2014 and U.S. Provisional Patent Application 62/018,715 entitled “Agricultural Apparatus for Collecting, Cutting and/or Processing Produce and Methods Thereof,” which was filed on Jun. 30, 2014, the entire disclosures of which are herein incorporated by reference.

### TECHNICAL FIELD

The present application generally relates to agricultural apparatus, and more particularly, relates to agricultural apparatus for collecting, cutting, and/or processing produce and to methods thereof.

### BACKGROUND

Many types of produce, e.g., romaine lettuce, are harvested by hand. After harvesting, such produce may require further treatment, e.g., collecting, cutting, and/or processing. With regard to romaine lettuce, for example, once harvested, it may be desirable to remove a top portion thereof prior to collection. Such removal, however, may require cutting a head of romaine lettuce by hand with a cutting tool, making multiple cuts across the head. This practice can lead to uneven surfaces across the head and/or variation amongst the finished products. Accordingly, additional embodiments related to agricultural apparatus for collecting, cutting, and/or processing produce and to methods thereof are desired.

### SUMMARY

In one embodiment, a produce processing system including a feed conveyor that extends between a loading end and a delivery end in a longitudinal direction, where the feed conveyor includes a first belt that extends between the loading end and the delivery end of the feed conveyor in the longitudinal direction a first spray assembly including a pump and a spray nozzle that is coupled to the feed conveyor, a flow sensor in fluid communication with the pump and the spray nozzle, a processing station, the processing station including a housing mounted to the feed conveyor and positionable over the feed conveyor, and a mandrel assembly coupled to the feed conveyor, the mandrel assembly including a first rotating blade, an engagement sensor coupled to the housing and the feed conveyor, a stop switch coupled to the feed conveyor, where the stop switch is repositionable between an engaged position and a disengaged position, and an operator controller communicatively coupled to the flow sensor, the engagement sensor, and the stop switch, where the operator controller stops a rotation of the first rotating blade based on at least one of a detection of a signal from the engagement sensor, a detected flow rate from the flow sensor, and an engagement of the stop switch.

In another embodiment, a produce processing system includes a feed conveyor that extends between a loading end and a delivery end in a longitudinal direction, where the feed conveyor includes a first belt that extends between the loading end and the delivery end of the feed conveyor in the longitudinal direction, a first spray assembly including a pump and a spray nozzle that is coupled to the feed conveyor, a flow sensor in fluid communication with the pump and the spray nozzle, a processing station, the processing station including a housing mounted to the feed conveyor and positionable over the feed conveyor, and a mandrel assembly coupled to the feed conveyor, the mandrel assembly including a first rotating blade, an engagement sensor coupled to the housing and the feed conveyor, a stop switch coupled to the feed conveyor, where the stop switch is repositionable between an engaged position and a disengaged position, and an operator controller communicatively coupled to the flow sensor, the engagement sensor, and the stop switch, where the operator controller stops a rotation of the first belt based on at least one of a detection of a signal from the engagement sensor, a detected flow rate from the flow sensor, and an engagement of the stop switch.

In yet another embodiment, an agricultural apparatus for collecting, cutting, and/or processing produce, the agricultural apparatus including a feed conveyor that extends between a loading end and a delivery end in a longitudinal direction, where the feed conveyor includes a first belt that extends between the loading end and the delivery end of the feed conveyor in the longitudinal direction, and a second belt that extends between the loading end and the delivery end of the feed conveyor in the longitudinal direction, where the second belt is spaced apart from the first belt in a lateral direction, a processing station, the processing station including a housing mounted to the feed conveyor, an axle attached to the feed conveyor, a first rotating blade operatively connected to the axle, a second rotating blade operatively connected to the axle, the second rotating blade spaced apart from the first rotating blade in the lateral direction, where the first rotating blade and the second rotating blade are positioned between the first belt and the second belt in the lateral direction and are at least partially encapsulated by the housing and where, in operation, the first rotating blade and the second rotating blade cut through produce passing from the loading end to the delivery end of the feed conveyor, and a byproduct drop-off positioned between the first rotating blade and the second rotating blade in the lateral direction, and a byproduct conveyor attached to the feed conveyor and positioned beneath the byproduct drop-off in a vertical direction.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, in which:

FIG. 1 is a front view of an agricultural apparatus for collecting, cutting, and/or processing produce, e.g., romaine lettuce, according to one or more embodiments shown or described herein;

FIG. 2 is a side perspective view of the agricultural apparatus of FIG. 1, with a close view of rotating blades and a cutting block according to one or more embodiments described herein;

FIG. 3 is a side view of a processing station of the agricultural apparatus of FIG. 1 according to one or more embodiments shown or described herein;

FIG. 4A is a perspective view of a mandrel assembly of the agricultural apparatus of FIG. 1 according to one or more embodiments shown or described herein;

FIG. 4B is an exploded perspective view of the mandrel assembly of FIG. 4A according to one or more embodiments shown or described herein;

FIG. 5 is a top perspective view of the rotating blades of the agricultural apparatus of FIG. 1 according to one or more embodiments shown or described herein;

FIG. 6 is a rear perspective view of the rotating blades of FIG. 5 and a cutting block according to one or more embodiments shown or described herein;

FIG. 7 is a side view of the agricultural apparatus of FIG. 1 with a byproduct collection conveyor according to one or more embodiments shown or described herein;

FIG. 8 is a top view of the agricultural apparatus of FIG. 1 with spray nozzles and side rails according to one or more embodiments shown or described herein;

FIG. 9 is a side perspective view of an agricultural apparatus for collecting, cutting, and/or processing produce with rotating blades on outer edges of a feed conveyor according to one or more embodiments shown or described herein;

FIG. 10 is a block diagram of an agricultural apparatus for collecting, cutting, and/or processing produce according to one or more embodiments shown or described herein;

FIG. 11 is a logic flowchart of a method for operating an agricultural apparatus for collecting, cutting, and/or processing produce according to one or more embodiments shown or described herein; and

FIG. 12 is a top perspective view of processed romaine lettuce.

### DETAILED DESCRIPTION

Embodiments of the present disclosure are directed toward agricultural apparatus for collecting, cutting, and/or processing produce, e.g., romaine lettuce, and to methods thereof. Reference will now be made in detail to embodiments of agricultural apparatus for collecting, cutting, and/or processing produce (hereinafter, “agricultural apparatus”). While specific mention is made herein to romaine lettuce, it should be understood that the term “produce” may include, without limitation, celery, leaf lettuce, escarole, frisee lettuce, Napa cabbage, and the like. As used herein, the term “agricultural apparatus” refers to a stationary system and/or a mobile system for use in a processing facility and/or a field. When used in a processing facility, for example, produce may be harvested in a field, transported from the field to the processing facility, and collected, cut, and/or processed therein. When used in a field, however, produce may be harvested, collected, cut, and/or processed therein. Additionally, in the field, the agricultural apparatus may be removably mounted to driven farm equipment, e.g., a tractor, harvester, and/or trailer, and may include wheels such that it may be towed behind the farm equipment. In some embodiments, the agricultural apparatus is used in a field only, and is not used in a processing facility.

The phrase “communicatively coupled” is used herein to describe the interconnectivity of various components of the agricultural apparatus and means that the various components are connected, such as, e.g., through wires, through optical fibers, and/or wirelessly such that electrical, optical, and/or electromagnetic signals may be exchanged therebetween.

As used herein, the term “longitudinal direction” refers to the forward-rearward direction of the agricultural apparatus (i.e., in the +/−Y-direction as depicted). The term “lateral direction” refers to the cross-direction (i.e., in the +/−X-direction as depicted), and is transverse to the longitudinal direction. The term “vertical direction” refers to the upward-downward direction of the agricultural apparatus (i.e., in the +/−Z-direction as depicted).

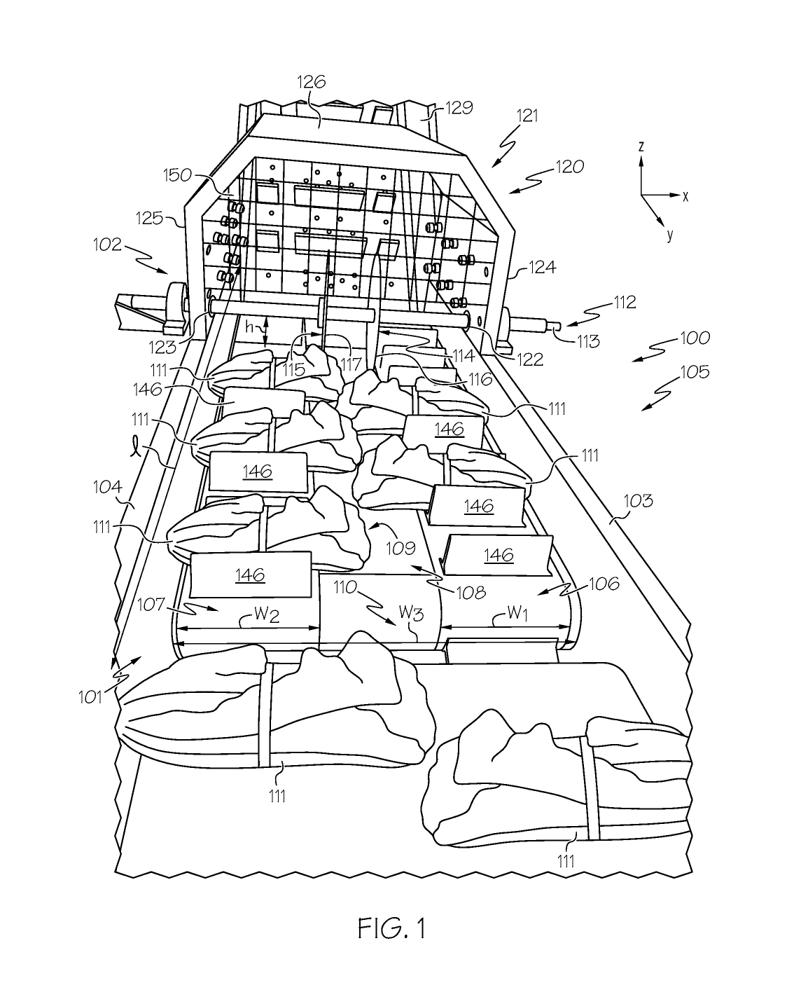

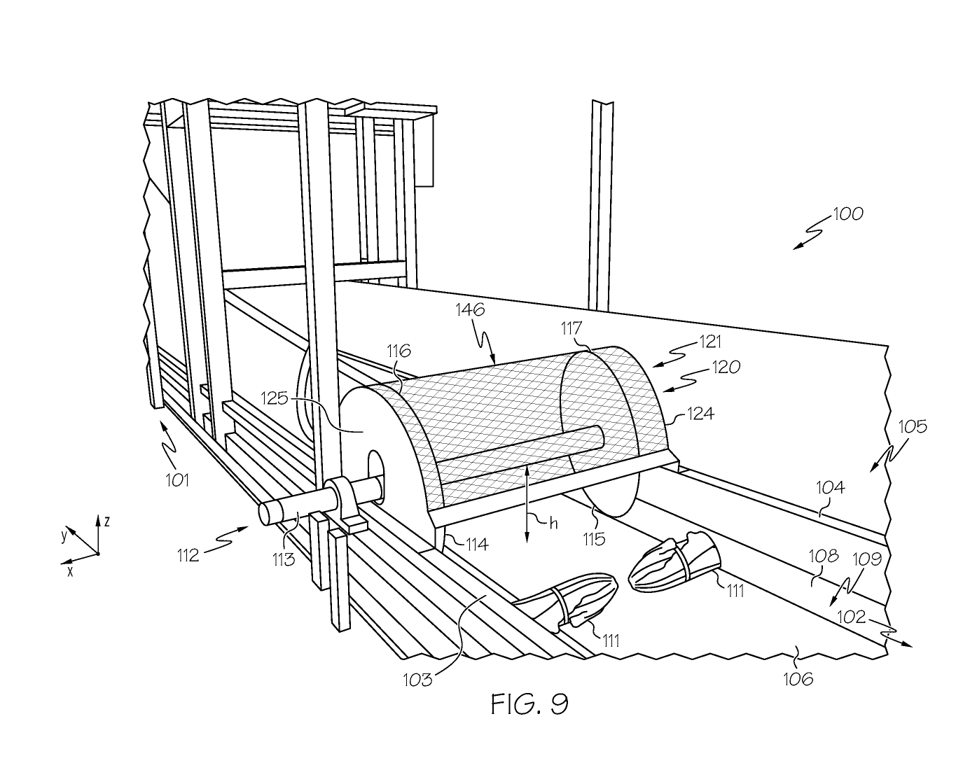

Embodiments of agricultural apparatus will now be described in detail with reference to FIGS. 1-10. Thereafter, embodiments of methods of collecting, cutting, and/or processing produce will be described with reference to FIGS. 1-12.

### I. Agricultural Apparatus

Referring to FIGS. 1-10, in one or more embodiments, an agricultural apparatus 100 includes a feed conveyor 105, a processing station 120 operatively connected to the feed conveyor 105, and/or a collection conveyor 129 operatively connected to the processing station 120 and/or to the feed conveyor 105. Embodiments of the feed conveyor 105 will now be described in detail with reference to FIGS. 1-3 and 5-10.

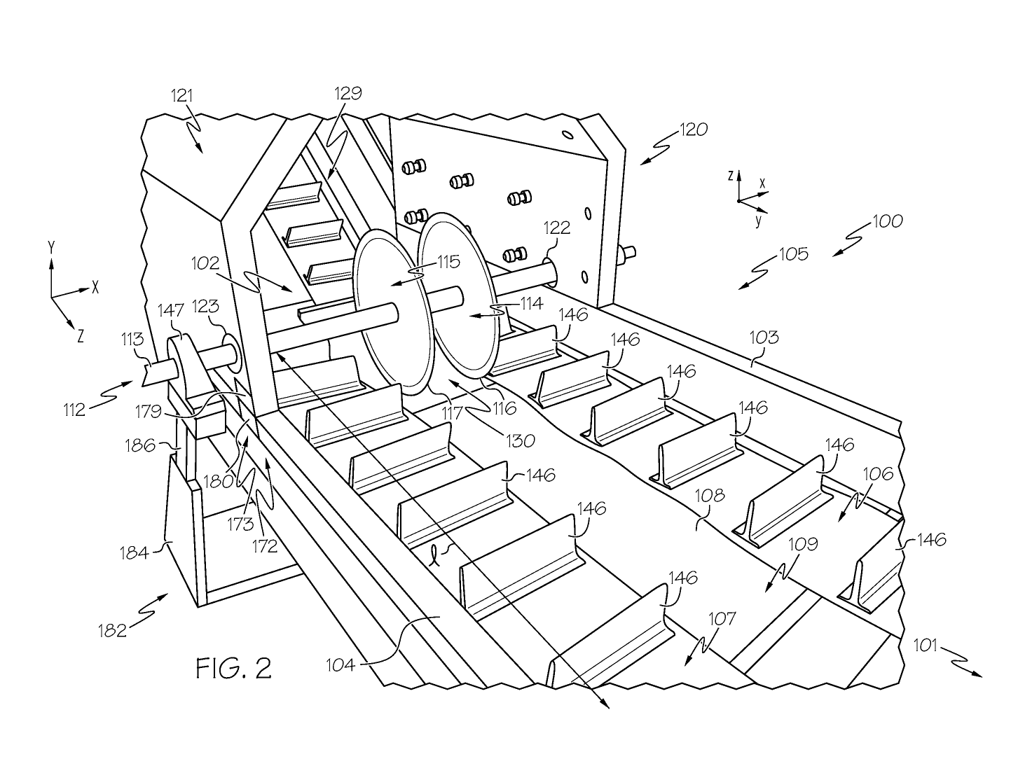

Referring to FIGS. 1-2, in one or more embodiments, the agricultural apparatus 100 includes the feed conveyor 105. In some embodiments, the feed conveyor 105 includes a decking 109, a first side wall, a second side wall 104, and at least one belt 106 or 107 rotatably attached to and/or attachable to the decking 109. In some embodiments, the decking 109 includes a top surface 108, a bottom surface (not shown), side surfaces (not shown), a loading end 101, and a delivery end 102. In some embodiments, the delivery end 102 and the loading end 101 are positioned opposite to each other in the longitudinal direction and the feed conveyor 105 extends between the loading end 101 and the delivery end 102.

In one or more embodiments, the first and/or second side walls 103, 104 are integral with, attached to, and/or attachable to the decking 109. The first and/or second side walls 103, 104 may be positioned opposite to and/or substantially parallel to each other. In one or more embodiments, the first side wall 103 and the second side wall 104 extend from the loading end 101 to the delivery end 102 of the decking 109 along a length “l” thereof in the longitudinal direction. In some embodiments, the first side wall 103 and the second side wall 104 of the agricultural apparatus 100 extend upward from the top surface 108 of the decking 109 of the feed conveyor 105 in the vertical direction.

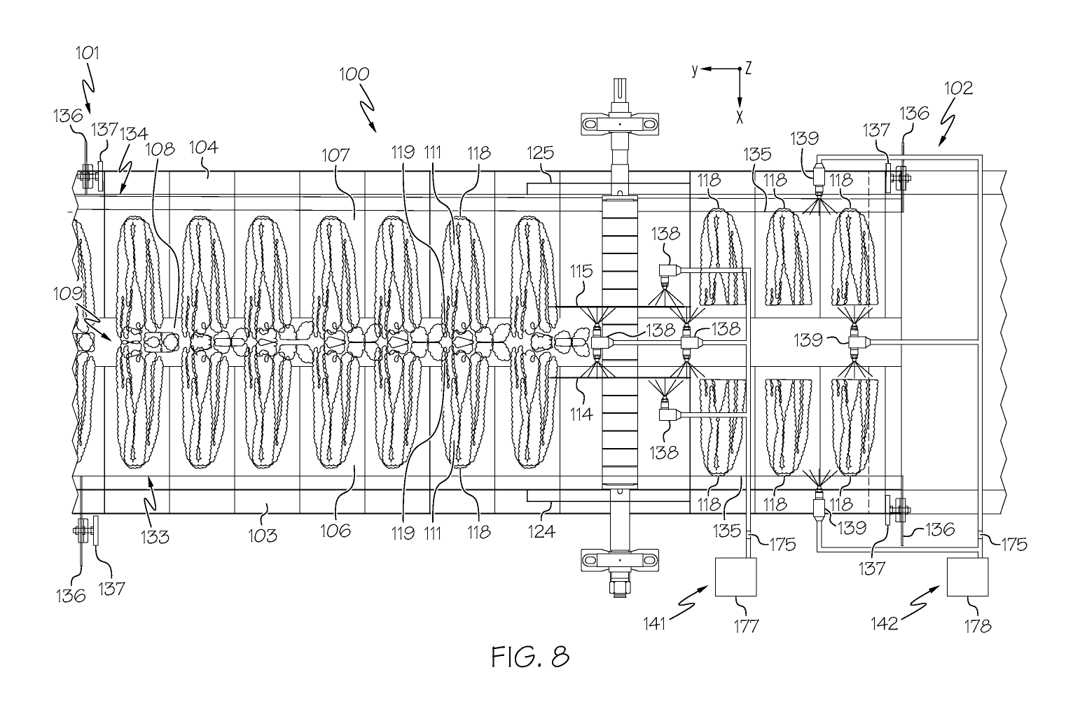

Referring now to FIG. 8, in one or more embodiments, the feed conveyor 105 includes at least one belt, i.e., a first belt 106. The first belt 106 may be positioned in between the first and/or second side walls 103, 104, respectively, in the lateral direction. The first belt 106 extends from the loading end 101 to the delivery end 102 of the feed conveyor 105 in the longitudinal direction. More particularly, the first belt 106 may extend from the loading end 101 to the delivery end 102 of the feed conveyor 105 over a top surface 108, a bottom surface (not shown), and side surfaces (not shown) of the decking 109.

Referring back to FIGS. 1-2, in one or more embodiments, the feed conveyor 105 includes at least two belts, i.e., the first belt 106 and a second belt 107. The first belt 106 and the second belt 107 are positioned in between the first side wall 103 and the second side wall 104 in the lateral direction. The first belt 106 and the second belt 107 may be spaced apart from each other in the lateral direction, such that the first belt 106 is proximate to the first side wall 103, the second belt 107 is proximate to the second side wall 104 and there is a gap in between the first belt 106 and the second belt 107. Where the first belt 106 and the second belt 107 are spaced apart, at least a portion of the top surface 108 of the decking 109 may be exposed.

The first belt 106 and the second belt 107 extend from the loading end 101 to the delivery end 102 of the feed conveyor 105 in the longitudinal direction. More particularly, the first belt 106 and the second belt 107 may extend from the loading end 101 to the delivery end 102 of the feed conveyor 105 over the top surface 108, the bottom surface (not shown), and the side surfaces (not shown) of the decking 109. The first belt 106 and/or the second belt 107 may each have a width, w₁ and w₂, as evaluated in the lateral direction, respectively. In some embodiments, the widths w₁ and w₂ of the first and/or second belts 106, 107 are independently selected such that at least a portion of the top surface 108 of the decking 109 is visible therebetween. For example, the combined widths w₁ and w₂ may be less than a width w₃ of the decking 109 evaluated in the lateral direction.

Referencing FIGS. 1-2, in some embodiments, each of the first belt 106 and/or the second belt 107 includes a plurality of flights 146. In some embodiments, the flights 146 may be integral with, attached to, and/or attachable to the first and/or second belts 106, 107. In one or more embodiments, the flights 146 are fixedly attached to the first and/or second belts 106, 107. In some embodiments, each of the plurality of flights 146 is oriented orthogonally to the first belt 106 and/or to the second belt 107. In some embodiments, the flights 146 extend across the widths w₁ or w₂ of the first and/or second belts 106, 107 in the lateral direction. The flights 146 retain the positioning of produce placed in between two of such flights 146 upon movement of the first and/or second belts 106, 107. In some embodiments, the flights 146 are spaced apart from one another such as to accommodate produce, e.g., romaine lettuce 111, therein. Distances in between each of the flights 146 may be the same and/or different, and may vary dependent upon the type of produce to be accommodated.

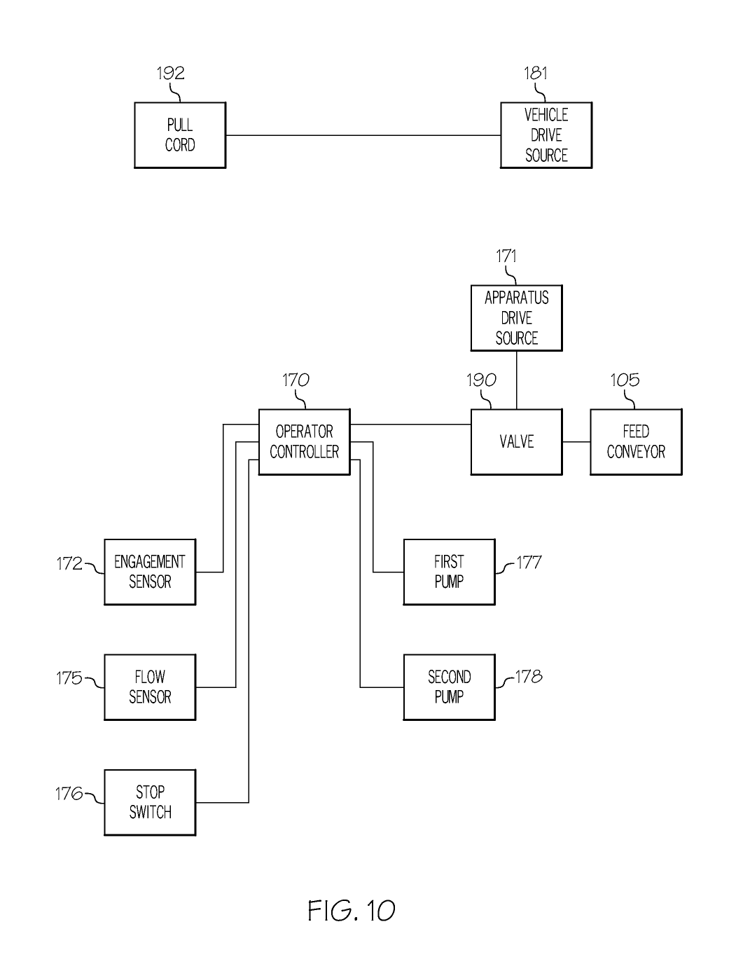

In one or more embodiments, the feed conveyor 105 is powered. Referring to FIG. 10, to power the feed conveyor 105, the feed conveyor 105 is mechanically coupled to an apparatus drive source 171. In embodiments, the apparatus drive source 171 may include a hydraulic motor (not shown). In embodiments wherein the agricultural apparatus 100 is mountable to farm equipment, the apparatus drive source 171 may include a hydraulic motor (not shown) of a piece of farm equipment, e.g., a tractor. It is contemplated, however, that the apparatus drive source 171 may include other drive source devices known in the art, including but not limited to, an internal combustion engine and/or an electric motor.

When the apparatus drive source 171 includes a hydraulic motor, the apparatus drive source 171 is in fluid communication with a valve 190. The valve 190 is in fluid communication with the feed conveyor 105. In this way, the apparatus drive source 171 is in fluid communication with the feed conveyor 105 through the valve 190. The valve 190 may be selectively opened or closed, so as to allow or prohibit fluid communication between the apparatus drive source 171 and the feed conveyor 105. Because the valve 190 may selectively allow or prohibit fluid communication between the apparatus drive source 171 and the feed conveyor 105, the valve 190 may selectively connect or disconnect hydraulic power provided to the feed conveyor 105 from the apparatus drive source 171.

The valve 190 is communicatively coupled to an operator controller 170, such that the valve 190 may receive signals from the operator controller 170. More specifically, the valve 190 may receive signals from the operator controller 170 such as signals to open or close the valve 190.

Referring back to FIGS. 1 and 2, in some embodiments wherein the feed conveyor 105 is powered, the first and/or second belts 106, 107 of the feed conveyor 105 are powered. To power the first and/or second belts 106, 107, the feed conveyor 105 may include a drive unit 110 mechanically coupled to the apparatus drive source 171. In some embodiments, the drive unit 110 rotates and is operatively engaged with the first and/or second belts 106, 107 such that the first and/or second belts 106, 107 may move around the decking 109. In further embodiments, the drive unit 110 rotates upon engagement of the apparatus drive source 171, causing the first and/or second belts 106/107 to move across the top surface 108 and around the decking, i.e., to move around the top surface 108, side surfaces (not shown), and bottom surface (not shown) of the decking 109. For example, when the apparatus drive source 171 is engaged, the drive unit 110 may rotate, causing the first and/or second belts 106, 107 to move around the decking 109. By rotating the drive unit 110 and moving the first and/or second belts 106, 107 across the top surface 108 of the decking 109, the first and/or second belts 106, 107 are capable of moving produce, e.g., heads of romaine lettuce 111, from the loading end 101 to the delivery end 102 of the agricultural apparatus 100 in the longitudinal direction.

Referring now to FIG. 8, in one or more embodiments, the feed conveyor 105 includes at least one side rail, i.e., a first side rail 133. The first side rail 133 may be movably attached and/or movably attachable to the first side wall 103 or the second side wall 104. In this embodiment, the first side rail 133 extends along a length of the first side wall 103 or the second side wall 104, and extends from the loading end 101 of the feed conveyor 105 to the delivery end 102 of the feed conveyor 105 in the longitudinal direction. In some embodiments, the first side rail 133 may extend along only a portion of the length of the first side wall 103 or the second side wall 104. In one or more embodiments, the first side rail 133 extends inward from the first side wall 103 or the second side wall 104 toward the exposed decking 109 in the lateral direction.

In alternative embodiments, the first side rail 133 may be movably attached and/or movably attachable to the decking 109 which is exposed in between the first and/or second belts 106, 107. In this embodiment, the first side rail 133 extends along a length of the decking 109 exposed in between the first and/or second belts 106, 107. In some embodiments, the first side rail 133 may extend along only a portion of the length of the decking 109. In this embodiment, the first side rail 133 may extend outward from the exposed decking 109 toward the first side wall 103 or the second side wall 104. The first side rail 133 may extend substantially parallel to the first side wall 103 and/or the second side wall 104.

In some embodiments, the feed conveyor 105 includes at least two side rails, i.e., a first side rail 133 and a second side rail 134. The first and second side rails 133, 134 may be movably attached and/or movably attachable to the first and/or second side walls 103, 104, respectively. Additionally, the first and second side rails 133, 134 may extend along the length of the first and/or second side walls 103, 104 respectively, extending from the loading end 101 to the delivery end 102 of the feed conveyor 105 in the longitudinal direction. In some embodiments, the first and second side rails 133, 134 may extend along only a portion of the length of the first side wall 103 or the second side wall 104. In one or more embodiments, the first side rail 133 extends inward from the first side wall 103 toward the exposed decking 109 in the lateral direction, and the second side rail 134 extends inward from the second side wall 104 toward the exposed decking 109 in the lateral direction.

In alternative embodiments, the first and second side rails 133, 134 may be movably attached and/or movably attachable to the decking 109 which is exposed in between the first and/or second belts 106, 107. In this embodiment, the first and second side rails 133, 134 extend along a length of the decking 109 exposed in between the first and/or second belts 106, 107, extending from the loading end 101 to the delivery end 102 of the feed conveyor 105. In some embodiments, the first and second side rails 133, 134 may extend along only a portion of the length of the decking 109. The first side rail 133 may extend outward from the exposed decking 109 toward the first side wall 103; similarly, the second side rail 134 may extend outward from the exposed decking 109 toward the second side wall 104. The first and second side rails 133 may extend substantially parallel to the first side wall 103 and/or the second side wall 104.

It is contemplated that the feed conveyor 105 may include any combination of first and second side rails 133, 134 as described herein. It is further contemplated that the feed conveyor 105 may include additional side rails, e.g., a third side rail (not shown), a fourth side rail (not shown), etc., as described herein with regard to the first and second side rails 133, 134.

Still referring to FIG. 8, in one or more embodiments, each of the first and second side rails 133, 134 includes a rail portion 135 and a slide portion 136. Each rail portion 135 of the first and second side rails 133, 134 extend in the longitudinal direction and may be used to guide produce placed on a top surface of the first and/or second belts, 106, 107 as the first and/or second belts 106, 107 move along the decking 109. Additionally, each rail portion 135 of the first and second side rails 133, 134 are moveably attached to the first and second side walls 103, 104 and may be used to adjust the positioning of produce placed on the top surface of the first and/or second belts, 106, 107. Such feature may provide workers with a mechanism to account for varying sizes, e.g., lengths, widths, etc., of produce, and will be described in greater detail below.

Each slide portion 136 is movably connected to the first side wall 103 or the second side wall 104. The slide portion 136 generally extends in the lateral direction and extends in a direction that is transverse to the slide portion 136. The slide portion 136 is operatively connected to the rail portion 135, such that the rail portion 135 is selectively translatable with respect to the first side wall 103 and/or the second side wall 104 in the lateral direction. For example, in one embodiment, the slide portion 136 is operatively connected to the rail portion 135 and the first and/or second side walls 103, 104 such that the rail portion 135 is slidably movable inward in the lateral direction toward the exposed decking 109 and/or is slidably movable outward in the lateral direction toward the first and/or second side walls 103, 104 respectively. Each of the first side rail 133 and the second side rail 134 may be slidably moved inward or outward from the first side wall 103 and the second side wall 104 respectively in the lateral direction. By moving the first side rail 133 and/or the second side rail 134 inward and/or outward from the first and/or second side walls 103, 104, the positioning of produce, e.g., heads of romaine lettuce 111, placed on the first and/or second belts 106, 107 may be adjusted. More particularly, the positioning of produce, e.g., heads of romaine lettuce 111, placed on the first and/or second belts 106, 107 may be adjusted with respect to rotating blades 114, 115 in the processing station 120 (which will be described in greater detail below).

In one or more embodiments, each of the slide portions 136 includes a plurality of tee handles 137. The tee handles 137 may engage the slide portion 136 of the first and/or second side rails 133, 134, respectively, retaining the slide portion 136 in place. The plurality of tee handles 137 includes spring loaded pins (not shown) that engage holes in the slide portion 136, allowing a worker to set and/or adjust the position of the first and/or second side rails 133, 134 at a number of predetermined positions. It is further contemplated, however, that the position of the first and/or second side rails 133, 134 may be set, adjusted, and/or retained by alternative mechanisms known in the art, such as, for example, a spring loaded tee handle engaging a slot and/or a set screw.

By way of example, the decking 109, first side wall 103, second side wall 104, first side rail 133, and second side rail 134, may be made from materials such as, e.g., metals, which are appropriate for use in agricultural apparatus. Such material may include, but should not be limited to, stainless steel and/or aluminum.

Referring now to FIGS. 1-3, in one or more embodiments, the agricultural apparatus 100 includes the processing station 120 that is operatively connected to the feed conveyor 105. In some embodiments, the processing station 120 includes a housing 121, a mandrel assembly 112 integral with, attached to, and/or attachable to the housing 121, a cutting board 130 attached to the decking 109, and/or a byproduct drop-off 131 defined by the cutting board 130 and/or the decking 109. The housing 121 may be integral with, attached to, and/or attachable to the feed conveyor 105. In embodiments where the housing 121 is attached to the feed conveyor 105, the axial position of the housing 121 relative to the feed conveyor 105 may be fixed by a mechanical feature (not depicted) such as a dowel pin or the like. The housing 121 may be attached to the feed conveyor 105 by a latching device (not depicted) such as an over-center latch, a draw latch or the like.

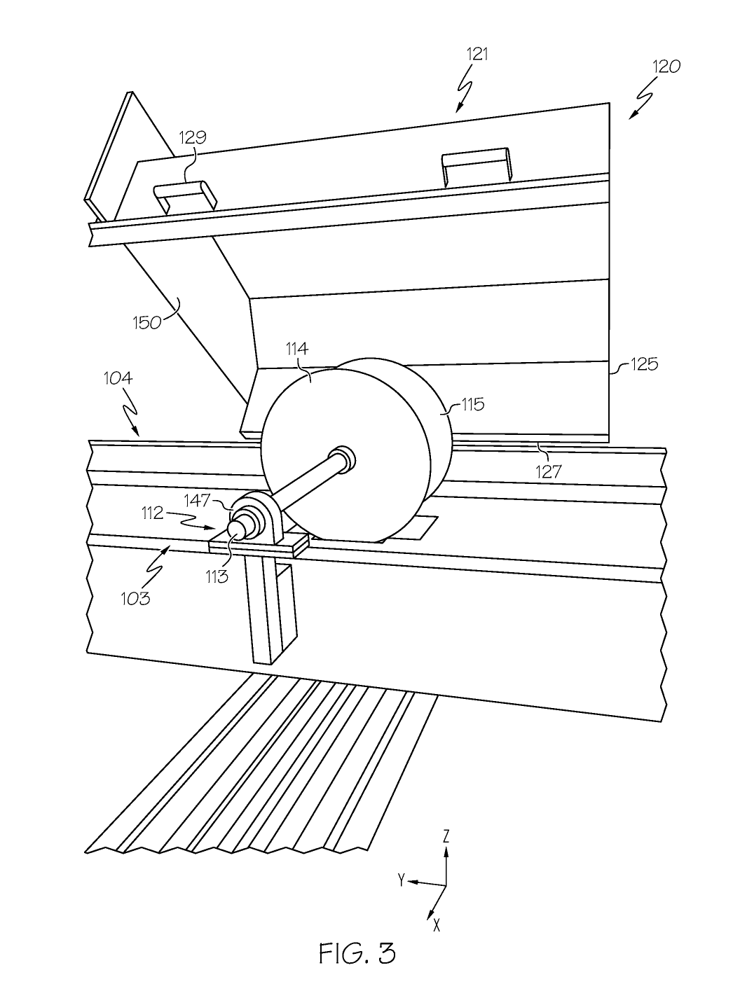

Referring to FIG. 3, in some embodiments, the housing 121 may be hingedly attached to the feed conveyor 105. Specifically, in some embodiments, the housing 121 may be attached to the second side wall 104 by at least one hinge member 127. Alternatively, the housing 121 may be attached to the first side wall 103 by at least one hinge member 127. By connecting the housing 121 to one of the first side wall 103 or second side wall 104, the housing 121 may be selectively lifted or closed over the feed conveyor 105, as depicted in FIG. 3. By selectively lifting or closing the housing 121 over the feed conveyor, the housing 121 may selectively encapsulate the mandrel assembly 112.

Referring to FIGS. 1-3, in one or more embodiments, the housing 121 includes a first wall 124, e.g., a first side wall, a second wall 125, e.g., a second side wall, and a top wall 126. The first wall 124 and the second wall 125 are adjacent to and attached to the top wall 126. In some embodiments, the first wall 124 and the second wall 125 respectively extend vertically upward from the first side wall 103 and the second side wall 104 of the feed conveyor 105. In further embodiments, the first wall 124 and the second wall 125 are respectively mounted to the first side wall 103 and the second side wall 104.

In some embodiments, the housing 121 further includes a front wall 150. In these embodiments, the front wall 150 is adjacent to the top wall 126 and to the first wall 124 and the second wall 125. In one or more embodiments, the front wall 150 extends downwardly from the top wall 126 toward the top surface 108 of the decking 109, while providing sufficient space therebetween to allow the entrance of produce into the housing 121. In some embodiments, the housing 121 may prevent and/or protect workers from inadvertently contacting the mandrel assembly 112 and/or first and/or second rotating blades 114, 115 provided therein, which are described in greater detail below. In further embodiments, the housing 121 and/or a portion thereof may include a cage-like material. For example, as shown in FIG. 1, in one or more embodiments, the front wall 150 of the housing 121 is a cage wall. The use of such a cage wall allows workers to see within the processing station 120 and/or housing 121, while preventing inadvertent contact with the first and/or second rotating blades 114, 115. Alternatively, the front wall 150 may be formed as a solid wall. The housing 121 may be selectively removable from the feed conveyor 105 to allow access to the mandrel assembly 112.

Referencing FIGS. 2 and 10, in some embodiments, an engagement sensor 172 is mechanically coupled to the housing 121 and the feed conveyor 105. The engagement sensor 172 is communicatively coupled to the operator controller 170, such that it may send signals to the operator controller 170. The engagement sensor 172 may include a magnetic switch 173 having a magnet portion 179 and a magnet sensor portion 180. The magnet sensor portion 180 may output signals indicating if the magnet portion 179 is proximate to the magnet sensor portion 180.

The magnet portion 179 may be mechanically coupled to the housing 121 and the magnet sensor portion 180 may be mechanically coupled to the feed conveyor 105. More specifically, the magnet sensor portion 180 may be mechanically coupled to the feed conveyor 105 proximate to the magnet portion 179. Alternatively, the magnet portion 179 may be mechanically coupled to the feed conveyor 105 and the magnet sensor portion 180 may be mechanically coupled to the housing 121. More specifically, the magnet sensor portion 180 may be mechanically coupled to the housing 121 proximate to the magnet portion 179.

As previously described, in some embodiments, the engagement sensor 172 is communicatively coupled to the operator controller 170. For example, the engagement sensor 172 may send a signal to the operator controller 170 indicating that the magnet portion 179 is proximate to the magnet sensor portion 180. Because the magnet portion 179 may be mechanically coupled to the housing 121 and the magnet sensor portion 180 may be mechanically coupled to the feed conveyor, proximity between the magnet portion 179 and the magnet sensor portion 180 may be indicative that the housing 121 is positioned over the feed conveyor 105, as is depicted in FIG. 2. The engagement sensor 172 may also send a signal to the operator controller 170 indicating that the magnet portion 179 is not proximate to the magnet sensor portion 180, which may be indicative that the housing 121 is not positioned over the feed conveyor 105 and the mandrel assembly 112 is exposed.

While reference has been made herein to an engagement sensor 172 that is magnetic, other engagement sensors known to those of ordinary skill in the art are contemplated. For example and without limitation, the engagement sensor 172 may include a tongue interlock switch, a solenoid tongue interlock switch, a hinge interlock switch, a limit switch, or the like.

Referring to FIGS. 2-3, in some embodiments, the mandrel assembly 112 is partially or wholly encapsulated within the housing 121. The mandrel assembly 112 may include an axle 113 and/or at least one rotating blade, i.e., a first rotating blade 114. Alternatively, the mandrel assembly 112 may include an axle 113 and/or at least two rotating blades, i.e., a first rotating blade 114 and a second rotating blade 115. In one or more embodiments, the mandrel assembly 112 is positioned proximate to the delivery end 102 of the agricultural apparatus 100 and/or above the feed conveyor 105.

Referring specifically to FIG. 2, the axle 113 is integral with, attached to, and/or attachable to the feed conveyor 105. In a further embodiment, the axle 113 is fixedly attached to the feed conveyor. Alternatively, the axle 113 may be coupled to the feed conveyor 105. In some embodiments, the axle 113 of the mandrel assembly 112 extends through a first opening 122 and a second opening 123 in the housing 121. In further embodiments, the first and second openings 122, 123 in the housing 121 are configured such that the axle 113 is free to rotate therein. In one or more embodiments, such as is shown in FIG. 1, the axle 113 is positioned at a height h above the top surface 108 of the decking 109 of the feed conveyor 105 in the vertical direction. The height h may be selected such that an outer edge 116 of the first rotating blade 114 and an outer edge 117 of the second rotating blade 115 extend at least to the first belt 106 and the second belt 107 on the top surface 108 of the decking 109. By selecting height h such that the outer edge 116 the first rotating blade 114 and the outer edge 117 of the second rotating blade 115 extend at least to the first belt 106 and second belt 107, the first rotating blade 114 and second rotating blade 115 are positioned so as to fully cut through the produce, e.g., heads of romaine lettuce 111 passing from the loading end 101 to the delivery end 102 of the agricultural apparatus 100.

Still referring to FIG. 2, in embodiments, the mandrel assembly 112 includes a pair of bearings 147 mechanically coupled to the axle 113. In some embodiments, each of the pair of bearings 147 is coupled to the axle 113 such that the axle 113 is rotatable with respect to the pair of bearings 147. The bearings 147 are mechanically coupled to the feed conveyor 105, thereby mechanically coupling the mandrel assembly 112 to the feed conveyor 105. In embodiments, each of the bearings 147 may be mechanically coupled to the housing 121. Alternatively, the bearings may be directly mechanically coupled to the feed conveyor 105.

In some embodiments, each of the bearings 147 may be mechanically coupled to a mounting assembly 182. The mounting assembly 182 may be mechanically coupled to the feed conveyor 105, as shown in FIG. 2. Alternatively, the mounting assembly 182 may be mechanically coupled to the housing 121. The mounting assembly 182 may include a base portion 184 and a telescoping portion 186. The telescoping portion 186 may be mechanically coupled to the base portion 184 such that the telescoping portion 186 may be extended or retracted with respect to the base portion 184 in the vertical direction.

In embodiments, each of the bearings 147 may be mechanically coupled to the telescoping portion 186. Because each of the bearings 147 may be mechanically coupled to the telescoping portion 186, the position of the bearings 147 may be extended or retracted with respect to the base portion 184 in the vertical direction. As such, the position of the bearings 147 may be adjustable in the vertical direction with respect to the decking 109. By adjusting the position of the bearings 147, the height h of the axle 113 and subsequently the position of the first rotating blade 114 and the second rotating blade 115 may be adjusted in the vertical direction.

The first rotating blade 114 and/or the second rotating blade 115 may be operatively connected to the axle 113, such that when the axle 113 is rotated, the first and/or second rotating blades 114, 115 are rotated. For example, in one or more embodiments, the first rotating blade 114 and/or the second rotating blade 115 are fixedly attached to the axle 113 such that rotation of the axle 113 provides rotation of the first and/or second rotating blades 114, 115. The first rotating blade 114 and the second rotating blade 115 are spaced apart from one another in the lateral direction. In some embodiments, the first and/or second rotating blades 114, 115, respectively, are axially positioned over the exposed portion the top surface 108 of the decking 109, positioned between the first and second belts 106, 107 in the lateral direction. In this particular embodiment, the first and/or second rotating blades 114, 115, are centrally attached to and positioned along a length of the axle 113 (such as is shown, e.g., in FIGS. 1-2 and 4-5). Such central positioning of the first and/or second rotating blades 114, 115 may be provided wherein the feed conveyor 105 includes a first and/or second belts 106, 107, respectively. However, such central positioning of the first and/or second rotating blades 114, 115 may also be provided wherein the feed conveyor 105 includes a first belt 106 only.

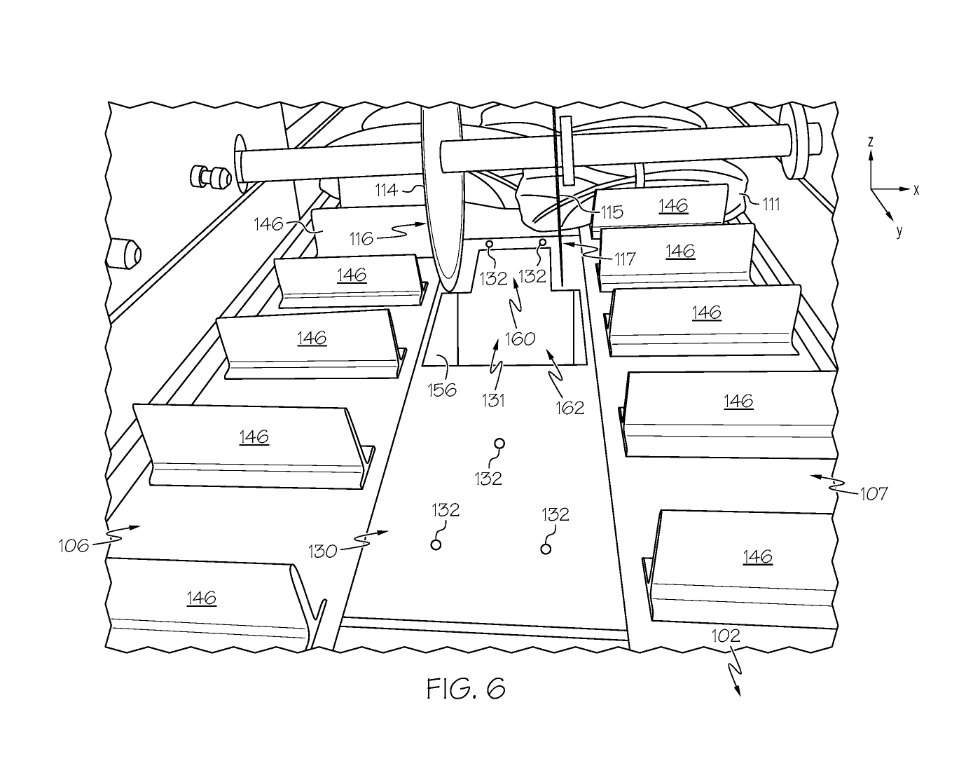

In alternative embodiments, the first and/or second rotating blades 114, 115, respectively, are outwardly attached to and/or positioned along outer edges of the axle 113 (such as is shown, e.g., in FIG. 6). In these embodiments, the first and/or second rotating blades 114, 115 attached to and/or are respectively positioned on the axle 113 on the outside of the first belt 106 proximate to the first wall 124 and the second wall 125 of the housing 121. Also in these embodiments, the first and/or second rotating blades 114, 115, may be positioned over an exposed portion of the top surface 108 of the decking 109, wherein the exposed portion is provided along outer edges (not shown) of the decking 109. Such outward positioning of the first and/or second rotating blades 114, 115 may be provided wherein the feed conveyor 105 includes a first belt 106 only. However, such outward positioning of the first and/or second rotating blades 114, 115 may also be provided wherein the feed conveyor 105 includes a first and/or second belts 106, 107, respectively (and any additional belts). Attachment and/or positioning of the first and/or second rotating blades 114, 115, over exposed portion(s) of the top surface 108 of the decking 109 may prevent damage to the first and/or second belts 106, 107 caused by rotation of the first and/or second rotating blades 114. 115.

In one or more embodiments, the first and/or second rotating blades 114, 115 are substantially circular in shape. In this embodiment, when operatively connected to the axle 113, the first and/or second rotating blades 114, 115 extend radially outward from the axle 113. An outer edge 116, e.g., circumference, of the first rotating blade 114 and an outer edge 117, e.g., circumference, of the second rotating blade 115 may be sharpened. While the outer edges 116 and 117 of the first and/or second rotating blades 114, 115, respectively, are sharpened in some embodiments, it is also contemplated that the first and/or second rotating blades 114, 115, may include sharpened teeth, a serrated edge, and/or any edge suitable for cutting produce.

The first and/or second rotating blades 114, 115 may be made from any material suitable for use in cutting produce. For example, in one embodiment, the first and/or second rotating blades 114, 115 may be made from stainless steel.

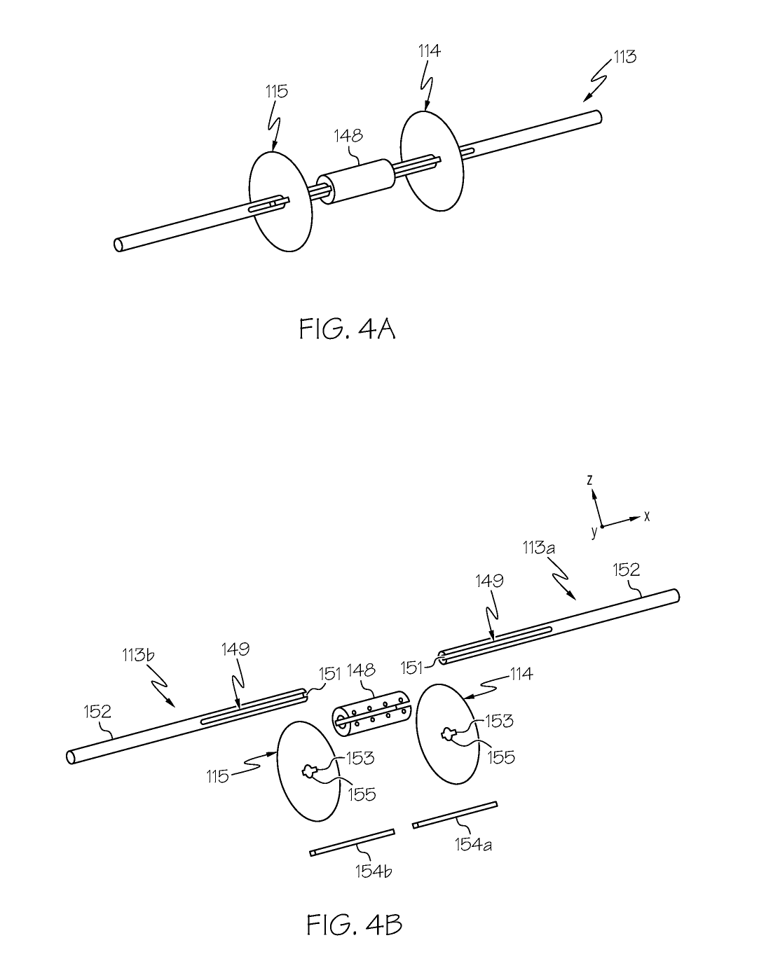

Referring now to FIGS. 4A and 4B, the axle 113 may include a first axle portion 113a and a second axle portion 113b. The first axle portion 113a and the second axle portion 113b may be mechanically coupled together by a shaft coupling 148. In some embodiments, each of the first axle portion 113a and the second axle portion 113b is at least partially inserted within the shaft coupling 148 to couple the first axle portion 113a to the second axle portion 113b.

In embodiments, each of the first axle portion 113a and the second axle portion 113b include a keyway 149 extending in the longitudinal direction. The keyway 149 may include a depression 151 within an outer circumference 152 of the axle 113.

The first rotating blade 114 and the second rotating blade 115 may include an inner diameter 155 that may be positioned over the outer circumference 152 of the first axle portion 113a and the second axle portion 113b, respectively. The inner diameter 155 of the first rotating blade 114 and the second rotating blade 115 may further include a key groove 153 extending radially outward from the inner diameter 155.

A first key portion 154a and a second key portion 154b may be positioned at least partially within the keyway 149 of the first axle portion 113a and the second axle portion 113b. The first key portion 154a and the second key portion 154b may function to restrict rotation of the first axle portion 113a with respect to the second axle portion 113b, and vice-versa. Likewise, the first key portion 154a and second key portion 154b may be positioned at least partially within the key groove 153 of the first rotating blade 114 and the second rotating blade 115. In this way, the first key portion 154a and the second key portion 154b may also function to restrict the rotation of the first rotating blade 114 with respect to the first axle portion 113a and the second rotating blade 115 with respect to the second axle portion 113b.

When the axle 113 includes the first axle portion 113a and the second axle portion 113b coupled by the shaft coupling 148, the first axle portion 113a may be decoupled from the second axle portion 113b without being removed from the mandrel assembly 112. Similarly, the second axle portion 113b may be decoupled from the first axle portion 113a without being removed from the mandrel assembly 112. Because the first axle portion 113a and the second axle portion 113b may be decoupled without being removed from the mandrel assembly 112, the first rotating blade 114 and the second rotating blade 115 may be removed and replaced from the axle 113 without requiring that the axle 113 be removed from the mandrel assembly 112. It is contemplated that removal of the first rotating blade 114 and/or the second rotating blade 115 from the axle without removing the axle 113 from the mandrel assembly 112 will reduce the time and effort required to replace a damaged blade 114, 115. While specific mention has been made herein to an axle 113 including a first axle portion 113a and a second axle portion 113b, it is contemplated that in some embodiments, the axle 113 may be formed from a single piece construction.

In one or more embodiments, the mandrel assembly 112 is powered by the apparatus drive source 171 (FIG. 10). For example, the apparatus drive source 171 may be mechanically coupled to the mandrel assembly 112 such that the mandrel assembly 112 is rotated when the apparatus drive source 171 is engaged.

In one or more embodiments, referring to FIGS. 1 and 8, the processing station 120 includes a first and/or second spray assembly 141, 142, respectively. The first spray assembly 141 may be integral with, attached to, and/or attachable to the housing 121. The second spray assembly 142 may be positioned within the housing 121 and may be integral with, attached to, and/or attachable to the decking 109 of the feed conveyor 105 and/or attached to the housing 121.

In one or more embodiments, the first spray assembly 141 includes at least one spray nozzle 138. In further embodiments, the first spray assembly 141 includes a plurality of spray nozzles 138, i.e., the first plurality of spray nozzles 138, coupled to the feed conveyor 105 and positioned within the housing 121. Each of the first plurality of spray nozzles 138 is in fluid communication with a fluid receptacle (not shown). Each of the first plurality of spray nozzles 138 may also be in fluid communication with a pump 177, i.e., the first pump 177. The first pump 177 may apply a pressure to fluid of the first spray assembly 141. By applying pressure to fluid of the first spray assembly 141, the first pump 177 may cause fluid from the fluid receptacle (not shown) to be dispensed by the first plurality of spray nozzles 138.

Referring to FIG. 10, in some embodiments, the first pump 177 is communicatively coupled to the operator controller 170 such that it may send signals to and receive signals from the operator controller 170. For example, the first pump 177 may receive control signals from the operator controller 170 commanding the first pump 177 to engage or disengage. When the first pump 177 is engaged, the first pump 177 is operable to and may apply pressure to the fluid in the first spray assembly 141. Thus, in embodiments wherein the first pump 177 is engaged, the first pump 177 causes at least a portion of the fluid to be dispensed from the first plurality of spray nozzles 138. In embodiments wherein the first pump 177 is disengaged, the first pump 177 does not apply pressure to the fluid in the first spray assembly 141 so that the fluid is not dispensed from the first plurality of spray nozzles 138.

In some embodiments, the first plurality of spray nozzles 138 are positioned within the housing 121 and to spray a fluid onto the first and/or second rotating blades 114, 115. More specifically, in some embodiments, the first plurality of spray nozzles 138 dispense and/or spray a fluid onto the first and/or second rotating blades 114, 115 in order to provide sanitation thereto and/or to cool and lubricate the first and/or second rotating blades 114, 115. For example, in some embodiments, at least one of the first plurality of spray nozzles 138 is positioned in between the first and/or second rotating blades 114, 115 in the lateral direction. At least one of the first plurality of spray nozzles 138 may also be respectively positioned in between the first rotating blade 114 and the first wall 124 and/or in between the second rotating blade 115 and the second wall 125 in the lateral direction. It is contemplated, however, that the first plurality of spray nozzles 138 may be positioned in any manner such that they may spray a liquid onto the first and/or second rotating blades 114, 115.

In embodiments, to position the first plurality of spray nozzles 138, the first plurality of spray nozzles 138 may be attached to and/or integral with the housing 121. Alternatively, the first plurality of spray nozzles 138 may be cantilevered into the housing 121.

In one or more embodiments, the second spray assembly 142 includes at least one spray nozzle 139. In further embodiments, the second spray assembly 142 includes a plurality of spray nozzles 139, i.e., the second plurality of spray nozzles 139, coupled to the feed conveyor 105. Each of the second plurality of spray nozzles 139 is in fluid communication with a fluid receptacle (not shown). Each of the second plurality of spray nozzles 139 may also be in fluid communication with a pump 178, i.e., the second pump 178. The second pump 178 may apply a pressure to fluid of the second spray assembly 142. By applying pressure to fluid of the second spray assembly 142, the second pump 178 may cause fluid from the fluid receptacle (not shown) to be dispensed by the second plurality of spray nozzles 139.

Referring to FIG. 10, in some embodiments, the second pump 178 is communicatively coupled to the operator controller 170 such that it may send signals to and receive signals from the operator controller 170. For example, the second pump 178 may receive control signals from the operator controller 170 commanding the second pump 178 to engage or disengage. When the second pump 178 is engaged, the second pump 178 is operable to and may apply pressure to the fluid in the second spray assembly 142. Thus, in embodiments wherein the second pump 178 is engaged, the second pump 178 causes at least a portion of the fluid to be dispensed from the second plurality of spray nozzles 139. In embodiments wherein the second pump 178 is disengaged, the second pump 178 does not apply pressure to the fluid in the second spray assembly 142 so that the fluid is not dispensed from the second plurality of spray nozzles 139.

In some embodiments, the second plurality of spray nozzles 139 are positioned within the housing 121 and/or positioned on the feed conveyor 105, and may spray a liquid onto produce which has been cut by the first and/or second rotating blades 114, 115. In embodiments, ones of the second plurality of spray nozzles 139 may be positioned on the first side wall and/or second side wall 103, 104 such that they may spray a base of a head of romaine lettuce 111. Additionally, in some embodiments, ones of the second plurality of spray nozzles 139 may be cantilevered above the feed conveyor 105 positioned between the first belt 106 and the second belt 107 in the lateral direction. The fluid, such as, e.g., a cleansing liquid, which is dispensed by the second plurality of spray nozzles 139 onto the freshly cut produce may act to seal the produce. For example, wherein the produce cut by the first and/or second rotating blades 114, 115 is romaine lettuce 111, the fluid dispensed by the second plurality of spray nozzles 139 may act to seal the freshly cut leaves. By sealing the freshly cut heads of romaine lettuce 111, the romaine lettuce may be sanitized and better preserved for transportation and/or further processing.

In some embodiments, the second plurality of spray nozzles 139 is positioned within the housing 121 proximate to the delivery end 102 of the feed conveyor 105. In one or more embodiments, the second plurality of spray nozzles 139 are positioned between the first and/or second rotating blades 114, 115 and the delivery end 102, such that they may spray onto produce which has been cut thereby. For example, in one embodiment wherein romaine lettuce 111 is fed into the housing 121 by the feed conveyor 105, after a top portion of the head of romaine lettuce 111 has been removed by the first and/or second rotating blades 114, 115, a smooth, internal surface of the romaine lettuce 111 is exposed. The second plurality of spray nozzles 139 may be positioned within the housing 121 such that they spray directly onto the smooth surface of the cut romaine lettuce 111 (and/or cut surfaces of other types of produce). In further embodiments, the second plurality of spray nozzles 139 are positioned within the housing 121 such that they may spray substantially centrally onto a cut surface of produce.

In embodiments, to position the second plurality of spray nozzles 139, the second plurality of spray nozzles 139 may be attached to and/or integral with the housing 121 and/or the feed conveyor 105. Additionally, ones of the second plurality of spray nozzles 139 may be cantilevered above the feed conveyor 105.

Referring to FIGS. 8 and 10, in some embodiments, each of the first and second spray assemblies 141 and 142 includes a flow sensor 175 in fluid communication with the first plurality of spray nozzles 138 and/or the second plurality of spray nozzles 139 and the first pump 177 and/or the second pump 178, respectively. Each of the respective flow sensors 175 may detect a flow of fluid through the first or second spray assemblies 141 and 142.

In some embodiments, the flow sensor 175 is communicatively coupled to the operator controller 170 such that the flow sensor 175 may send signals to the operator controller 170. For example, the flow sensor 175 may send a signal to the operator controller 170 indicating that the fluid flow through the first spray assembly 141 and/or the second spray assembly 142 is lower than a predetermined flow rate. In one embodiment, the predetermined flow rate may be about 8 gallons per minute. In another embodiment, the predetermined flow rate may be about 15 gallons per minute. Additionally, examples of flow rates wherein the flow sensor 175 may send a signal to the operator controller 170 indicating that the fluid flow is lower than a predetermined flow rate include, but should not be limited to, greater than about 0.75 gallons per minute and less than about 4 gallons per minute, greater than about 1 gallon per minute and less than about 3.5 gallons per minute, and greater than about 1.5 gallons per minute and less than about 3 gallons per minute.

Several factors may influence the flow rate through the first spray assembly 141 and/or the second spray assembly 142. For example, a blockage in one of the first plurality of spray nozzles 138 may cause the detected flow rate through the first spray assembly 141 to decrease. Similarly, a blockage in one of the second plurality of spray nozzles 139 may cause the detected flow rate through the second spray assembly 142 to decrease. By detecting the flow rate through the first spray assembly 141 and/or the second spray assembly 142 and determining if the detected flow rate is less than a predetermined flow rate, the flow sensor 175 may assist in identifying blockages in the first plurality of spray nozzles 138 and/or the second plurality of spray nozzles 139.

In one embodiment, the flow sensor 175 may be a 0.75-4 gallon/min adjustable flow switch. A suitable commercial embodiment of such flow sensor 175 includes, but should not be limited to flow switch part number 4980K4 available from the McMaster-Carr Supply Company.

Each of the first and second spray assemblies 141, 142 may spray a cleaning fluid onto the first and/or second rotating blades 114, 115 and the cut produce, respectively. The fluid, e.g., liquid, sprayed by the first and/or second spray assemblies 141, 142 may include any cleansing fluid suitable for sanitizing equipment utilized for collecting, cutting, and/or processing produce and/or for sanitizing produce. By way of example, the cleansing fluids may include, but are not limited to chlorinated water, water, and/or salt solutions. When the cleansing fluids include a solution such as a water/salt solution, the first and/or second spray assembly 141, 142 may include one or more agitator pumps (not depicted) to mix and/or agitate the solution. In some embodiments, the first spray assembly 141 and the second spray assembly 142 are equipped with the same cleansing fluid. In alternative embodiments, the first spray assembly 141 and the second spray assembly 142 are equipped with different cleansing fluids.

Referring to FIG. 6, in one or more embodiments, the processing station 120 may include at least one cutting board 130. In some embodiments, the cutting board 130 is disposed on the top surface 108 of the exposed decking 109. In further embodiments, the cutting board 130 is disposed on the top surface 108 of the exposed decking 109 directly beneath the mandrel assembly 112. In still further embodiments, the cutting board 130 is positioned on the top surface 108 of the exposed decking 109 in between the first belt 106 and/or second belt 107 directly beneath the first and/or second rotating blades 114, 115. In embodiments, the cutting board 130 may be removed from the decking 109 without removing the first and/or second rotating blades 114, 115 from the mandrel assembly 112. In this way, the cutting board 130 may be readily replaced in the event that the first and/or second rotating blades 114, 115, cause damage thereto. The cutting board 130 may be fastened and/or attached to the exposed portion of the decking 109 such that a top surface of the cutting board 130 is substantially level with the top surface 108 of the exposed portion of the decking 109. In some embodiments, the cutting board 130 may be fastened to the decking 109 by use of appropriate fasteners, e.g., at least one screw 132, nails, nuts, bolts, epoxy, and/or glue. By way of example, the cutting board may be made from a variety of materials, including but not limited to, ultra high molecular weight polyethylene (i.e., UHMW), nylon, and/or other thermoplastic resins known in the art.

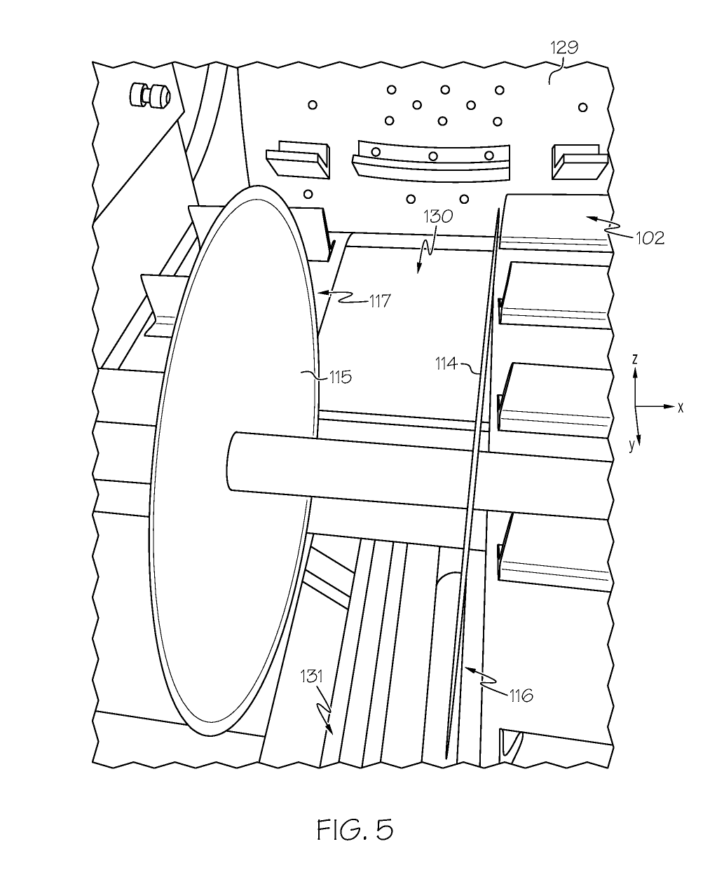

Referring now to FIGS. 5-7, in one or more embodiments, the processing station 120 includes a byproduct drop-off 131. The byproduct drop-off 131 is positioned between the first rotating blade 114 and the second rotating blade 115 in the lateral direction. In some embodiments, the byproduct drop-off 131 is positioned in between the first belt 106 and the second belt 107 of the feed conveyor 105 in the lateral direction. The byproduct drop-off 131 is a cavity defined by the cutting board 130 and/or the decking 109. In embodiments not including a cutting board 130, the byproduct drop-off is defined by the decking 109. The byproduct drop-off 131 serves to remove a portion of the product cut by the first and/or second rotating blades 114, 115. For example, when produce e.g., romaine lettuce 111, is moved from the loading end 101 to the delivery end 102 of feed conveyor 105, top portions, i.e., tips of the romaine lettuce leaves, are severed by the first rotating blade 114 and/or the second rotating blade 115 prior to encountering the byproduct drop-off 131. Once severed, the top portions of the produce will fall through the byproduct drop-off 131, and the remainder of the produce will continue moving toward the delivery end 102 of the feed conveyor 105. In some embodiments, the byproduct drop off 131 may include a chute 156 extending between the cutting board 130 and a collection and/or storage receptacle (not depicted) that may be placed beneath the byproduct drop-off 131 for collection of produce therein.

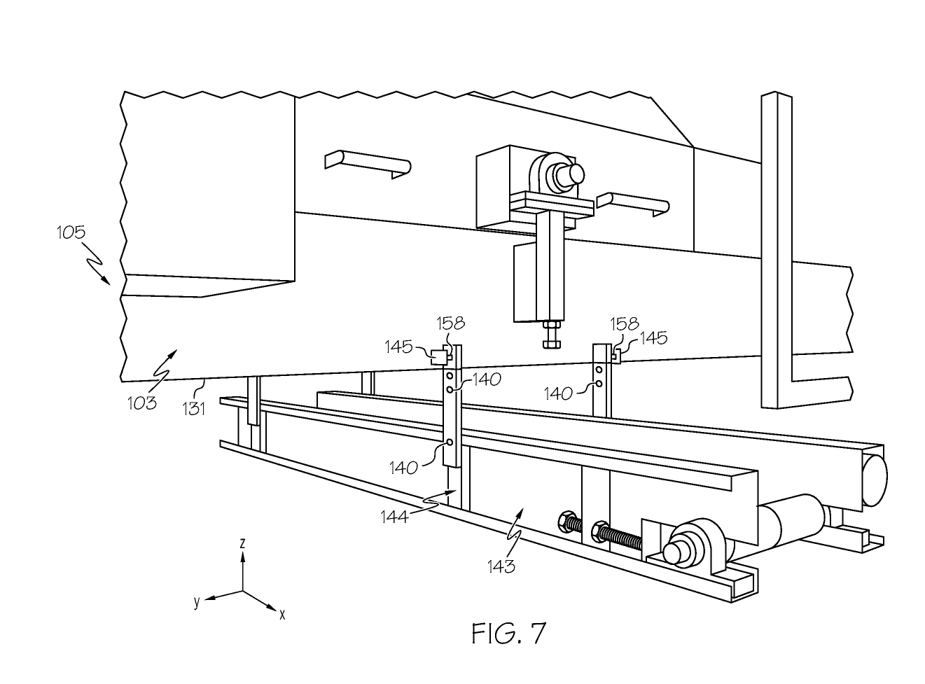

Referring to FIG. 7, in some embodiments a byproduct conveyor 143 may be placed beneath the byproduct drop-off 131 for collection of produce. The byproduct conveyor 143 may be positioned beneath and may be attached and/or attachable to the feed conveyor 105. The byproduct conveyor 143 may oriented transverse to the feed conveyor 105 and may extend in the lateral direction. In embodiments, the byproduct conveyor 143 may be powered such that the byproduct conveyor 143 carries produce that has fallen through the byproduct drop off 131 outward from the feed conveyor 105 for collection. In embodiments where the byproduct conveyor 143 is powered, the byproduct conveyor 143 may be mechanically coupled to the apparatus drive source 171, similar to the feed conveyor 105 as described above.

The byproduct conveyor 143 may be attached to the feed conveyor 105 by one or more connecting member 144 or connecting members 144. The connecting members 144 may extend downward from the feed conveyor 105 to the byproduct conveyor 143 in the vertical direction. The connecting members 144 may be connected to the feed conveyor 105 by one or more pins 158. Specifically, the connecting members 144 may include one or more holes 140 positioned on the connecting members 144. The feed conveyor 105 may include one or more brackets 145 attached to the feed conveyor 105. The pins 158 may be positioned in the brackets 145 and may be positioned in the holes 140 of the connecting members 144, connecting the connecting members 144 to the feed conveyor 105. In embodiments, the connecting members 144 may include multiple holes 140 on the connecting members 144. By selectively placing the pins 158 in different holes 140 of the connecting members 144, the byproduct conveyor 143 may selectively positioned with respect to the feed conveyor 105 in the vertical direction.

Referring back to FIG. 6, the chute 156 may separate the byproduct drop-off 131 from the first belt 106 and the second belt 107 positioned on the bottom surface of the decking 109. By separating the byproduct drop-off 131 from the first belt 106 and the second belt 107, the chute 156 may prevent the portion of the product cut by the first and/or second rotating blades 114, 115 from contacting the first belt 106 and the second belt 107. By preventing the portion of the product cut by the first and/or second blades 114, 115 from contacting the first belt 106 and the second belt 107, the chute 156 may prevent the first belt 106 and the second belt 107 from becoming fouled with the severed product.

Referring specifically to FIG. 6 in some embodiments, the byproduct drop-off 131 is substantially T-shaped. In these embodiments, the byproduct drop-off 131 includes a narrower section 160 and a wider section 162. The narrower section 160 is closer to the loading end 101 of the feed conveyor 105 and the wider section 162 is closer to delivery end 102 of the feed conveyor 105. In some embodiments, the T-shaped byproduct drop-off 131 is disposed in between the first belt and/or the second belt 106, 107 of the feed conveyor 105 in the lateral direction. In further embodiments, the T-shaped byproduct drop-off 131 is disposed in between the first belt and the second belt 106, 107 of the feed conveyor 105 and directly under the first and/or second rotating blades 114, 115. In still further embodiments, the height h of the axle 113 is selected such that at least a portion of the first and/or second rotating blades 114, 115 extend into the narrower section 160 of the byproduct drop-off 131. In this way, at least a portion of the outer edges 116, 117 of the first and/or second rotating blades 114, 115 may extend beneath the top surface 108 of the decking 109. By extending the outer edge 116 of the first rotating blade 114 and the outer edge 117 of the second rotating blade 115 beneath the top surface 108 of the decking 109, the first and/or second rotating blades 114, 115 may be positioned such that the first and/or second rotating blades 114 may cut completely through the produce, e.g., heads of romaine lettuce 111, as the produce is moved therethrough by the first and/or second belts 106, 107.

Referring to FIG. 10, in embodiments, a stop switch 176 is communicatively coupled to the operator controller 170. In some embodiments, the stop switch 176 is mechanically coupled to the feed conveyor 105. The stop switch 176 may include an engaged position, and a disengaged position. The stop switch 176 may be configured so that a user may toggle the stop switch 176 between the engaged position and the disengaged position. For example and without limitation, the stop switch 176 may comprise a pushbutton, where the pushbutton is depressed in the engaged position and the pushbutton is released in the disengaged position. The stop switch 176 may send signals to the operator controller 170, such as whether the stop switch 176 is in the engaged position or in the disengaged position.

Referring to FIG. 10, the operator controller 170 includes electrical and/or electro-mechanical switches (not depicted) that facilitate the operation of the agricultural apparatus 100. More specifically, the operator controller 170 may include electrical and/or electro-mechanical switches (not depicted) that are communicatively coupled to the engagement sensor 172, the flow sensor 175, the stop switch 176, the valve 190, the first pump 177, and/or the second pump 178 as described above. The electrical and/or electro-mechanical switches (not depicted) may selectively open and close to facilitate the operation of the agricultural apparatus 100, as will be described in greater detail below.

As described hereinabove, in some embodiments the agricultural apparatus 100 may be coupled to driven farm equipment, e.g., a tractor, harvester, and/or trailer. When the agricultural apparatus is coupled to driven farm equipment, the driven farm equipment may include a vehicle drive source 181 that is separate and independent from the apparatus drive source 171. The vehicle drive source 181 may include an internal combustion engine (not depicted), an electric motor (not depicted), or an internal combustion engine/electric motor hybrid (not depicted).

When the agricultural apparatus 100 is coupled to driven farm equipment, the agricultural apparatus may include a pull cord 192. The pull cord 192 may include a switch that is communicatively coupled to the vehicle drive source 181. In embodiments, the pull cord 192 may be communicatively coupled to an ignition of the vehicle drive source 181.

In other embodiments, when the vehicle drive source 181 includes an internal combustion engine, the pull cord 192 may be communicatively coupled to an engine control unit (ECU) of the internal combustion engine. When the vehicle drive source 181 includes an electric motor or an internal combustion engine/electric motor hybrid, the pull cord 192 may be communicatively coupled to a motor controller of the electric motor or internal combustion/electric motor hybrid.

In embodiments where the pull cord 192 is communicatively coupled to the ignition, the ECU, or the motor controller of the vehicle drive source 181, the pull cord 192 may selectively disengage the vehicle drive source 181.

In some embodiments, referring to FIGS. 1-2, the agricultural apparatus 100 includes a collection conveyor 129 connected to and/or operatively connected to the delivery end 102 of the feed conveyor 105. The collection conveyor 129 may include a loading end (not shown), a delivery end (not shown), a decking (not shown), a first side wall (not shown) integral with, attached to, and/or attachable to the decking (not shown), a second side wall (not shown) integral with, attached to, and/or attachable to the decking (not shown), and at least one belt 106 rotatably attached to and/or attachable to the decking (not shown). Such features are as previously described with regard to the feed conveyor 105. Additionally, the collection conveyor 129 may be powered as previously described with regard to the feed conveyor 105.

While the collection conveyor 129 is depicted as being substantially parallel to the feed conveyor 105, in embodiments, the collection conveyor 129 may be positioned substantially perpendicular to the feed conveyor 105. By positioning the collection conveyor 129 to be substantially perpendicular to the feed conveyor 105, the overall length of the feed conveyor 105 and the collection conveyor 129 in the longitudinal direction may be reduced. By reducing the overall length of the feed conveyor 105 and the collection conveyor 129, the maneuverability of the agricultural apparatus 100 may be improved when the agricultural apparatus 100 is towed by a tractor, harvester, and/or other farm equipment. For example, the turning radius of the agricultural apparatus 100 may be improved with a decreased overall length.

In further embodiments, the collection conveyor 129 may be elevated. For example, the loading end (not shown) of the collection conveyor 129 may be provided at a position substantially aligned with the delivery end 102 of the feed conveyor 105 such that cut and/or processed produce may be easily transported from the delivery end 102 of the feed conveyor 105 to the loading end (not shown) of the collection conveyor 129. However, the delivery end (not shown) of the collection conveyor 129 may be positioned at a height substantially greater than that of its loading end (not shown) and/or that of the delivery end 102 of the collection conveyor 129. Such elevation of the collection conveyor 129 may function to transport cut and/or processed produce from the feed conveyor 105 to a storage receptacle. In some embodiments, such storage receptacles may be placed on a piece of farm equipment.

While the collection conveyor 129 depicted in FIGS. 1 and 2 may be positioned to be substantially aligned with the delivery end 102 of the feed conveyor 105, the collection conveyor 129 may also be positioned to be substantially perpendicular to the delivery end 102 of the feed conveyor 105.

In some embodiments, the agricultural apparatus 100 includes a third conveyor 128 operatively connected to the loading end 101 of the feed conveyor 105. The third conveyor 128 may be configured to convey heads of romaine lettuce 111 to the loading end 101 of the feed conveyor 105. Additionally, the third conveyor may include the features of the feed conveyor 105 as previously described.

Embodiments of agricultural apparatus have been described in detail. Embodiments of methods of collecting, cutting, and/or processing produce will now be described with reference to FIGS. 1-12.

II. Methods for Collecting, Cutting, and/or Processing Produce

In one or more embodiments, methods of collecting, cutting, and/or processing produce utilizing the agricultural apparatus 100 as previously described herein are disclosed. In some embodiments, the methods include loading produce onto a feed conveyor 105, transporting the produce into a processing station 120, cutting the produce with a mandrel assembly 112 within the processing station 120, removing a portion of the cut produce with a byproduct drop-off 131 within the processing station 120, sanitizing the produce with the first and/or second spray assemblies 141, 142 within the processing station 120, transporting the produce from the processing station 120 to the collection conveyor 129, and/or transporting the produce to a storage receptacle (not shown).

Referring to FIG. 1, in one or more embodiments, produce, such as e.g., romaine lettuce 111, is loaded onto the feed conveyor 105. The produce may be loaded at or near the loading end 101 of the feed conveyor 105 by placing the produce onto the first and/or second belts 106, 107. In some embodiments, the produce should be positioned on the first and/or second belts 106, 107 such that the produce will come into contact with the mandrel assembly 112 upon movement through the processing station 120. More particularly, in some embodiments, the produce should be positioned on the first and/or second belts 106, 107 such that the portion of the produce of which removal is desired is aligned with the first and/or second rotating blades 114, 115.

With particular regard to romaine lettuce 111, as shown in FIG. 1, when the first and/or second rotating blades 114, 115 are centrally positioned, heads of the romaine lettuce 111 may be placed onto the first belt 106 in an orientation wherein a base 118 thereof is proximate to the first side wall 103. Similarly, heads of romaine lettuce 111 may be placed on the second belt 107 in an orientation wherein the base 118 is proximate to the second side wall 104. In some embodiments, the first and/or second side walls 103, 104 restrict the position of the base 118 of the heads of romaine lettuce 111 such that top portion or tips of the romaine lettuce leaves 119 opposite the base 118 are positioned over the partially exposed top surface 108 of the decking 109 of the feed conveyor 105.

With particular regard to romaine lettuce 111, referencing FIG. 8, when the first and/or second rotating blades 114, 115 are positioned on the outside of the feed conveyor 105, heads of romaine lettuce 111 are loaded onto the feed conveyor 105 with the tips of the romaine lettuce leaves 119 proximate to and/or facing either the first side wall 103 or the second side wall 104, and with the base 118 of the head of romaine lettuce 111 toward a center of the feed conveyor 105.

In embodiments wherein the feed conveyor 105 includes first and/or second side rails 133, 134, the first and/or second side rails 133, 134 may be slidably adjusted to accommodate for produce of varying size. In some embodiments, the first and/or second side rails 133, 134 may be adjusted by moving the rail portions 135 thereof inwardly and/or outwardly toward the exposed decking 109 and/or the first and/or second side walls 103, 104.

With particular regard to romaine lettuce 111, referencing FIG. 8, when the first side rail 133 is moved inward, away from the first side wall 103, the base 118 of the heads of romaine lettuce 111 may be moved closer to the first rotating blade 114. As a result, more of the heads of romaine lettuce 111 may be removed upon contact with the first rotating blade 114. When the first side rail 133 is moved outward, closer to the first side wall 103, the base 118 of the head of romaine lettuce 111 is moved farther away from the first rotating blade 114. As a result, less of the heads of romaine lettuce 111 may be removed upon contact with the first rotating blade 114. The second side rail 134 may be slidably moved inward or outward with relation to the second side wall 104, similarly altering the amount of the heads of romaine lettuce 111 cut by the second rotating blade 115.

Upon loading the produce onto the feed conveyor 105, the produce may be transported into a processing station 120. Movement of the first and/or second belts 106, 107 of the feed conveyor 105 may be achieved upon powering. Upon powering, the first and/or second belts 106, 107 may begin rotating, causing the produce placed thereon to move across the top surface of the decking 109. During such movement (and also while stationary), the first and/or second side walls 103, 104 may act to guide the produce, e.g., heads of romaine lettuce 111, as the first belt 106 and/or the second belt 107 move the produce from the loading end 101 toward the delivery end 102, thus transporting the produce into the processing station 120.

Upon transporting the produce into the processing station 120, continued movement of the first and/or second belts 106, 107 will bring the produce into contact with the first and/or second rotating blades 114, 115, when properly aligned. Such contact will result in the produce being cut.

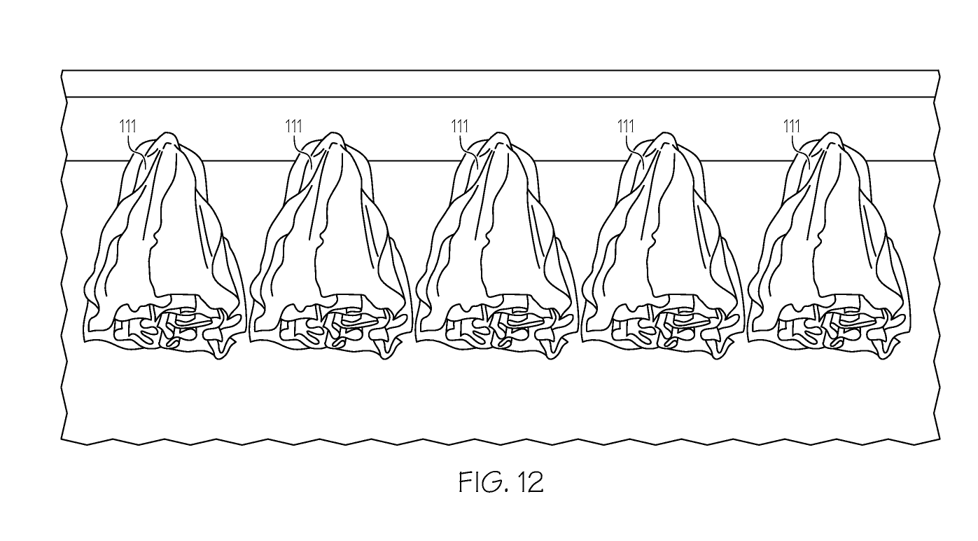

With particular regard to heads of romaine lettuce 111, movement of the first and/or second belts 106, 107 may bring the heads of romaine lettuce 111 placed thereon into contact with the first and/or second rotating blades 114, 115. Such contact with the first and/or second rotating blades 114, 115, will result in severing the top portion or tips of the romaine lettuce leaves 119 from the heads of romaine lettuce. During such cutting process, the first spray assembly 141 may dispense a cleansing fluid onto the first and/or second rotating blades 114, 115. Turning to FIG. 12, cut heads of romaine lettuce 111 are depicted. The tips of the leaves of the romaine lettuce have been severed from the heads of lettuce in a clean and straight cut that is uniform across the heads of romaine lettuce 111.

Upon cutting of the produce with the mandrel assembly 112, a portion of the cut produce may be removed from the feed conveyor 105 by dropping into the byproduct drop-off 131. If desired, cut produce may be collected in a storage receptacle beneath the byproduct drop-off 131.

Upon cutting of the produce with the mandrel assembly 112, the produce may be sanitized. More particularly, continued movement of the first and/or second belts 106, 107 may bring the produce into a region wherein the second spray assembly 142 may dispense a cleansing fluid onto the cut surface of the produce. More particularly, with regard to heads of romaine lettuce, referencing FIG. 8, continued movement of the first and/or second belts 106, 107 toward the delivery end 102 of the agricultural apparatus 100 bring the heads of romaine lettuce into contact with a spray of fluid as the romaine lettuce 111 exits the first rotating blade 114 and second rotating blade 115. In some embodiments, the cleansing fluid is sprayed centrally onto the cut surface of the romaine lettuce. Such procedure may provide clean produce.

Upon sanitizing the produce, the produce may be transported from the processing station 120 to the collection conveyor 129. Continued movement of the first and/or second belts 106, 107 will transport the produce to the delivery end 102 of the feed conveyor 105 and onto the loading end (not shown) of the collection conveyor 129. Upon powering of the collection conveyor 129, the produce delivered thereon may move across a top surface of the decking thereof to a storage receptacle.

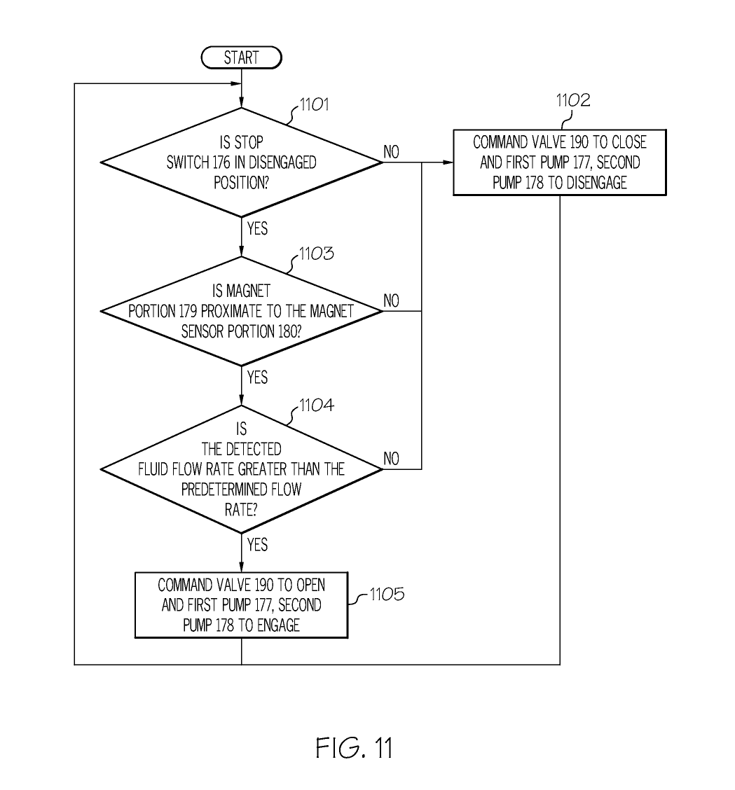

Referring to FIG. 11, one embodiment of a method for controlling the agricultural apparatus 100 is depicted in the flowchart of FIG. 11. In a first step 1101, the operator controller 170 detects a position of the stop switch 176. More specifically, the electronic controller detects if the stop switch 176 is in the disengaged position. If the operator controller 170 detects that the stop switch 176 is not in the disengaged position, then at step 1102, the electrical and/or electro-mechanical switches of operator controller 170 will selectively open or close such that the operator controller commands the valve 190 to close and the first pump 177, and the second pump 178 to disengage. If the operator controller 170 detects that the stop switch 176 is in the disengaged position, then the operator controller 170 proceeds to step 1103. At step 1103, the operator controller 170 detects if the magnet portion 179 is proximate to the magnet sensor portion 180 of the engagement sensor 172. If the operator controller 170 does not detect that the magnet portion 179 is proximate to the magnet sensor portion 180 of the engagement sensor 172, the operator controller 170 proceeds to step 1102 and the electrical and/or electro-mechanical switches of operator controller 170 will selectively open or close such that the operator controller commands the valve 190 to close and the first pump 177, and the second pump 178 to disengage. If the operator controller 170 detects that the magnet portion 179 is proximate to the magnet sensor portion 180 of the engagement sensor, the operator controller 170 proceeds to step 1104. At step 1104, the electronic controller detects a fluid flow rate from the flow sensor 175 of the first spray assembly 141 and/or the second spray assembly 142. If the operator controller 170 detects a fluid flow rate that is not above the predetermined fluid flow rate, then the operator controller 170 proceeds to step 1102 and the electrical and/or electro-mechanical switches of operator controller 170 will selectively open or close such that the operator controller commands the valve 190 to close and the first pump 177, and the second pump 178 to disengage. If the operator controller 170 detects a fluid flow rate above the predetermined fluid flow rate, the electrical and/or electro-mechanical switches of operator controller 170 will selectively open or close such that the operator controller commands the valve 190 to open and the first pump 177, and the second pump 178 to engage.

In the embodiment of the method for operating the agricultural apparatus 100 depicted in the flow chart of FIG. 11, the step of detecting position of the stop switch (i.e., step 1101), the step of detecting the proximity of the magnet portion 179 to the magnet sensor portion 180 (i.e., step 1103), and the step of detecting fluid flow rate and comparing the detected flow rate to a predetermined flow rate (i.e., step 1104) are depicted and described in a specific order and in combination. However, it should be understood that these steps may be performed in any order (e.g., step 1104 may be performed before step 1101, etc.) or even simultaneously. It is contemplated that methods for operating the agricultural apparatus 100 may include any single step or combination of steps (i.e., step 1101, step 1103, step 1104, alone or in any combination) described above. Further it is contemplated that the operator controller may command any single component or combination of components (i.e., the command valve 190, the first pump 177, and the second pump 178) to engage/disengage or open/close based on any of the steps described above.

As described above, the apparatus drive source 171 may provide power to the first belt 106, second belt 107, and the mandrel assembly 112. As also described above, the apparatus drive source 171 is in fluid communication with the feed conveyor 105 through the valve 190. When the valve 190 is closed, then the first belt 106, the second belt 107, and/or the mandrel assembly 112 may be disengaged, so that the first belt 106, the second belt 107, and/or the mandrel assembly 112 are not in motion. Similarly, as described above the first pump 177 and the second pump 178 may cause fluid to be dispensed by the first plurality of spray nozzles 138 and the second plurality of spray nozzles 139. When the first pump 177 and the second pump 178 are disengaged, fluid is not dispensed by the first plurality of spray nozzles 138 and the second plurality of spray nozzles 139.

By closing or opening the valve 190 based on the engagement of the stop switch 176, then the first belt 106, the second belt 107, and/or the mandrel assembly 112 may be disengaged by the engagement of the stop switch 176. Similarly, by determining the engagement of the first pump 177 and the second pump 178 based on the engagement of the stop switch 176, the fluid may cease to be dispensed by the first plurality of spray nozzles 138 and/or the second plurality of spray nozzles 139 based on the engagement of the stop switch 176.

As described above, the proximity of the magnet portion 179 to the magnet sensor portion 180 may indicate that the housing 121 is positioned over the feed conveyor 105. By closing or opening the valve 190 based on the proximity of the magnet portion 179 to the magnet sensor portion 180, then the first belt 106, the second belt 107, and the mandrel assembly 112 may be disengaged when the magnet portion 179 is not proximate to the magnet sensor portion 180. Similarly, by determining the engagement of the first pump 177 and the second pump 178 based on the proximity of the magnet portion 179 to the magnet sensor portion 180, the fluid may cease to be dispensed by the first plurality of spray nozzles 138 and/or the second plurality of spray nozzles 139 when the magnet portion 179 is not proximate to the magnet sensor portion 180. As described above, when the magnet portion 179 is not proximate to the magnet sensor portion 180, the housing 121 may have been removed from and/or may be misaligned with the feed conveyor 105, exposing the mandrel assembly 112. Accordingly, by closing or opening the valve 190 based on the proximity of the magnet portion 179 to the magnet sensor portion 180, the first belt 106, the second belt 107, and the mandrel assembly 112 may be disengaged when housing 121 is removed from the feed conveyor 105 and the mandrel assembly 112 is exposed. Additionally, the first belt 106, the second belt 107, and the mandrel assembly 112 may be disengaged when the housing is misaligned with the feed conveyor 105.

Also as described above, the flow sensor 175 may assist in identifying blockages in the first plurality of spray nozzles 138 and/or the second plurality of spray nozzles 139. By opening or closing the valve 190 based on whether a detected fluid flow is less than a predetermined fluid flow rate, then the first belt 106, the second belt 107, and/or the mandrel assembly 112 may be disengaged when the detected fluid flow is less than the predetermined fluid flow rate. In some embodiments, the first belt 106, the second belt 107, and the mandrel assembly 112 are disengaged when the detected fluid flow is less than the predetermined fluid flow rate. In some embodiments, the first pump 177 and the second pump 178 are disengaged when the detected fluid flow is less than the predetermined fluid flow rate. As described above, when the detected fluid flow is less than the predetermined fluid flow rate, a blockage may be present in the first plurality of spray nozzles 138 and the second plurality of spray nozzles 139. Accordingly, when a blockage is present in the first plurality of spray nozzles 138 and the second plurality of spray nozzles 139, then the first belt 106, the second belt 107, and/or the mandrel assembly 112 may be disengaged, preventing produce from being processed when a blockage is present in the first plurality of spray nozzles 138 and/or the second plurality of spray nozzles 139. By preventing produce from being processed when a blockage is present in the first plurality of spray nozzles 138 and/or the second plurality of spray nozzles 139, the agricultural apparatus 100 may ensure that sufficient fluid is dispensed on the first rotating blade 114, the second rotating blade 115, and the romaine lettuce 111.

In some embodiments, such methods may be performed in the field only. In other embodiments, such methods may be performed in a processing facility.

The terms “a,” “an,” and “the”, as used herein, refer to “one or more.” For example, reference to “an apparatus” may include both reference to a single apparatus and reference to a plurality of apparatus.

It is to be further understood that where descriptions of various embodiments use the term “comprising,” and/or “including” those skilled in the art would understand that in some specific instances, an embodiment can be alternatively described using language “consisting essentially of” or “consisting of.”

While particular embodiments of the present disclosure have been illustrated and described, it would be obvious to one skilled in the art that various other changes and modifications can be made without departing from the spirit and scope of the disclosure. It is therefore intended to cover in the appended claims all such changes and modifications that are within the scope of this disclosure.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

What is claimed is:

1. A produce processing system comprising:
a feed conveyor that extends between a loading end and a delivery end in a longitudinal direction, wherein the feed conveyor comprises a first belt that extends between the loading end and the delivery end of the feed conveyor in the longitudinal direction;
a first spray assembly comprising a pump and a spray nozzle that is coupled to the feed conveyor;
a flow sensor in fluid communication with the pump and the spray nozzle;
a processing station, the processing station comprising:
a housing mounted to the feed conveyor and positionable over the feed conveyor; and
a mandrel assembly coupled to the feed conveyor, the mandrel assembly comprising a first rotating blade;
an engagement sensor coupled to the housing and the feed conveyor;
a stop switch coupled to the feed conveyor, wherein the stop switch is repositionable between an engaged position and a disengaged position; and
an operator controller communicatively coupled to the flow sensor, the engagement sensor, and the stop switch, wherein the operator controller stops a rotation of the first rotating blade based on at least one of a detection of a signal from the engagement sensor, a detected flow rate from the flow sensor, and an engagement of the stop switch.

2. The produce processing system of claim 1, further comprising a valve and an apparatus drive source, wherein the apparatus drive source is in fluid communication with the feed conveyor through the valve.

3. The produce processing system of claim 2, wherein the valve is communicatively coupled to the operator controller, and wherein the operator controller stops the rotation of the first rotating blade by closing the valve.

4. The produce processing system of claim 1, wherein when the engagement sensor detects that the housing is not positioned over the feed conveyor, the operator controller stops the rotation of the first rotating blade.

5. The produce processing system of claim 1, wherein when the flow sensor detects a flow rate that is not greater than a predetermined flow rate, the operator controller stops the rotation of the first rotating blade.

6. The produce processing system of claim 1, wherein when the stop switch is positioned in the engaged position, the operator controller stops the rotation of the first rotating blade.

7. The produce processing system of claim 1, wherein the operator controller commands the pump of the first spray assembly to disengage based on at least one of the detection of a position of the housing from the engagement sensor, the detected flow rate from the flow sensor, and the engagement of the stop switch.

8. A produce processing system comprising:
a feed conveyor that extends between a loading end and a delivery end in a longitudinal direction, wherein the feed conveyor comprises a first belt that extends between the loading end and the delivery end of the feed conveyor in the longitudinal direction;
a first spray assembly comprising a pump and a spray nozzle that is coupled to the feed conveyor;
a flow sensor in fluid communication with the pump and the spray nozzle;
a processing station, the processing station comprising:
a housing mounted to the feed conveyor and positionable over the feed conveyor; and
a mandrel assembly coupled to the feed conveyor, the mandrel assembly comprising a first rotating blade;
an engagement sensor coupled to the housing and the feed conveyor;
a stop switch coupled to the feed conveyor, wherein the stop switch is repositionable between an engaged position and a disengaged position; and
an operator controller communicatively coupled to the flow sensor, the engagement sensor, and the stop switch, wherein the operator controller stops a rotation of the first belt based on at least one of a detection of a signal from the engagement sensor, a detected flow rate from the flow sensor, and an engagement of the stop switch.

9. The produce processing system of claim 8, further comprising a valve and an apparatus drive source, wherein the apparatus drive source is in fluid communication with the feed conveyor through the valve.

10. The produce processing system of claim 9, wherein the valve is communicatively coupled to the operator controller, and wherein the operator controller stops the rotation of the first belt by closing the valve.

11. The produce processing system of claim 8, wherein when the engagement sensor detects that the housing is not positioned over the feed conveyor, the operator controller stops the rotation of the first belt.

12. The produce processing system of claim 8, wherein when the flow sensor detects a flow rate that is not greater than a predetermined flow rate, the operator controller stops the rotation of the first belt.

13. The produce processing system of claim 8, wherein when the stop switch is positioned in the engaged position, the operator controller stops the rotation of the first belt.

14. The produce processing system of claim 8, wherein the operator controller commands the pump of the first spray assembly to disengage based on at least one of the detection of a position of the housing from the engagement sensor, the detected flow rate from the flow sensor, and the engagement of the stop switch.

15. The produce processing system of claim 8, wherein the operator controller stops a rotation of the first belt based on at least one of the detection of a position of the housing from the engagement sensor, the detected flow rate from the flow sensor, and the engagement of the stop switch.

16. An agricultural apparatus for collecting, cutting, and/or processing produce, the agricultural apparatus comprising:
a feed conveyor that extends between a loading end and a delivery end in a longitudinal direction, wherein the feed conveyor comprises:
a first belt that extends between the loading end and the delivery end of the feed conveyor in the longitudinal direction; and
a second belt that extends between the loading end and the delivery end of the feed conveyor in the longitudinal direction, wherein the second belt is spaced apart from the first belt in a lateral direction;
a processing station, the processing station comprising:
a housing mounted to the feed conveyor;
an axle attached to the feed conveyor;
a first rotating blade operatively connected to the axle;
a second rotating blade operatively connected to the axle, the second rotating blade spaced apart from the first rotating blade in the lateral direction, wherein the first rotating blade and the second rotating blade are positioned between the first belt and the second belt in the lateral direction and are at least partially encapsulated by the housing and wherein, in operation, the first rotating blade and the second rotating blade cut through produce passing from the loading end to the delivery end of the feed conveyor; and
a byproduct drop-off positioned between the first rotating blade and the second rotating blade in the lateral direction; and
a byproduct conveyor attached to the feed conveyor and positioned beneath the byproduct drop-off in a vertical direction.

17. The agricultural apparatus of claim 16, further comprising a connecting member that attaches the byproduct conveyor to the feed conveyor, wherein the connecting member comprises one or more holes and at least one pin that is selectively placed into the one or more holes to selectively position the byproduct conveyor in the vertical direction.

18. The agricultural apparatus of claim 16, wherein the byproduct conveyor is oriented transverse to the feed conveyor.

19. The agricultural apparatus of claim 16, further comprising a first spray assembly having a first plurality of spray nozzles coupled to the feed conveyor, in which at least one of the first plurality of spray nozzles is positioned between the first rotating blade and the second rotating blade in the lateral direction.

20. The agricultural apparatus of claim 16, further comprising a second spray assembly having a second plurality of spray nozzles coupled to the feed conveyor and positioned between the first rotating blade and the second rotating blade and the delivery end of the feed conveyor in the longitudinal direction.
